(19) United States
(12) Patent Application Publication
(10) Pub. No.: US 2013/0255877 A1
(43) Pub. Date: Oct. 3, 2013

(54) MULTIFUNCTIONAL THERMO-VACUUM-AIR PRESSURIZED FORMING MACHINE

(71) Applicant: FLEXTRONICS AP, LLC, Broomfield, CO (US)

(72) Inventors: Spring Wu, Zhuhai (CN); Banghong Hu, Zhuhai (CN); Oliver Ren, Zhuhai (CN); Charles Raymon Hill, Loudonville, OH (US)

(73) Assignee: FLEXTRONICS AP, LLC, Broomfield, CO (US)

(21) Appl. No.: 13/762,175

(22) Filed: Feb. 7, 2013

Related U.S. Application Data
(60) Provisional application No. 61/613,313, filed on Mar. 20, 2012.

(51) Int. Cl. B32B 37/10

(52) U.S. Cl. CPC B32B 37/1018
USPC 156/272.2; 156/285; 156/382; 156/380.9

(57) ABSTRACT

Systems and methods of applying a decorating film to a substrate that reduce the occurrence of wrinkling of the decorating film during application of the film to the substrate and ensure a more uniform transfer of a pattern or image on the decorating film to the substrate. The same systems and methods can be used to apply a decorating film that laminates to a substrate. Systems of and methods for cooling a decorating chamber and removing the used decorating film from the substrate after a transfer of an image or pattern from the decorating film to the substrate.

### CROSS-REFERENCE TO RELATED APPLICATIONS

This non-provisional patent application is a continuation-in-part under 35 U.S.C. §120 of the co-pending U.S. patent application Ser. No. 12/840,884, filed Jul. 21, 2010, and entitled “DIFFUSION DECORATION TECHNOLOGY”, which in turn claims the benefit under 35 U.S.C. §119(e), of U.S. Provisional Patent Application Ser. No. 61/267,634, entitled “DIFFUSION DECORATION TECHNOLOGY”, and this application further claims the benefit under 35 U.S.C. §119(e), of U.S. Provisional Patent Application Ser. No. 61/613,313, entitled “MULTIFUNCTIONAL THERMO-VACUUM-AIR PRESSURIZED FORMING MACHINE”, filed Mar. 20, 2012, by inventors Spring Wu, Banghong Hu, Oliver Ren, and Charles Raymon Hill all of which are hereby incorporated by reference in their entirety for all purposes.

### FIELD OF THE INVENTION

The present invention relates to the field of transferring a decorative image to a substrate or workpiece. More specifically, the present invention relates to systems for and methods of applying a decorating film comprising the decorative image to the substrate.

### BACKGROUND OF THE INVENTION

A substrate can be decorated with a pattern or image, termed a graphic, by use of a decorating film that is heated to activate a transfer of ink or dye to the substrate, thereby transferring the graphic to the substrate. To uniformly apply the graphic to the substrate, the decorating film must be applied to the substrate without wrinkling the decorating film. It is also desirable to apply a force to the decorating film, urging the decorating film into contact with the substrate to effectively transfer the image to the substrate. Applying a force to the decorating film further exacerbates the problem of the decorating film wrinkling or not making uniform contact with the substrate, thereby reducing the quality of the graphic transferred to the substrate.

### SUMMARY OF THE INVENTION

The presently-claimed invention teaches systems for and methods of applying a decorating film to a substrate that reduce the occurrence of wrinkling of the decorating film during application of the film to the substrate and ensure a more uniform transfer to the substrate of a pattern or image on the decorating film. The presently-claimed invention also discloses systems of and methods for cooling a decorating chamber and removing the used decorating film from the substrate after a transfer of an image or pattern from the decorating film to the substrate. The systems and methods can also be used to apply a decorating film to a substrate that laminates to the substrate.

A high-resolution, multi-color image can be acquired for creating a decorating film. The decorating film is then applied to a surface of a wide variety of articles without changing the setup of the graphics application process and without incurring the environmental and waste problems of paint over-spray. The decorative image is diffused into the surface of the article to be decorated. Diffusion dyes or inks permeate into, and below, the surface of the substrate such that the transferred image is both on, and in, the substrate material. The presently-claimed invention also can be used before, during, or after manufacture of an article to be decorated, unlike paint and decals which are typically applied at post-manufacturing by the manufacturer.

The presently-claimed invention provides systems and methods for detailed, multi-colored decoration of surface of an article by diffusing ink into the article surface. A decorative image is acquired for creating a decorating film, the decorating film is secured to the article in a chamber, heat is applied to the chamber, and the decorative image is transferred into the article by diffusing the inks of the decorating film into the article to be decorated. A system for decorating a surface of an article can include a general purpose computing system and a scanner for acquiring and storing decorative images. The system can further include a multi-color printer for printing the decorative images onto a blank decorating film using diffusion inks, thereby creating a decorating film. The article to be decorated is placed on a mount. The dimensions of the mount are such that the mount holds the surface of the article to be decorated substantially parallel to an opening of a chamber. The mounted article is placed inside the chamber. The decorating film is larger than the opening of the chamber. When the decorating film is placed onto the opening, and thereby onto the article to be decorated, the printed face is directed toward the surface of the article to be decorated and such that the decorating film overlaps the opening of the chamber. A retaining frame is placed over the decorating film and coupled to the chamber thereby fixing the relative positions of the chamber, the decorating film, and the article to be decorated mounted inside the chamber. In some embodiments, the chamber, decorating film and the retaining frame form an air-tight chamber with the article to be decorated inside the air-tight chamber. The chamber is then mounted to a heating machine. In some embodiments, the heating machine includes a vacuum source and an optional air intake source, coupled to the chamber to draw a vacuum inside the chamber, thereby pulling the transfer down more firmly onto the surface of the article to be decorated. Valves coupled to the air intake and the vacuum source, and a vacuum pump, are able to control the level of vacuum inside the chamber. A heating source is then lowered over the chamber and secured into position. In some embodiments, the heating source is locked into position to facilitate personnel safety while the heating source is in the ON state. The heat source is applied to the decorating film, chamber, and the article to be decorated for a predetermined heating cycle. When the heating cycle is complete, the heat source can be removed and the chamber allowed to cool. When the chamber is cool, the retaining frame is removed, the used decorating film is discarded or recycled, and the finished decorated article is removed. In some embodiments, the vacuum pump, air intake valve and vacuum source valve can be operated to draw an air flow through the chamber to enhance the cooling of the chamber. In some embodiments, a vent duct in the heat source vents heat from the heat source at the end of the cooling cycle to assist in cooling the heat source thereby facilitating personnel safety. In some embodiments, the heat source, vacuum pump, air intake valve and vacuum valve are interfaced to a control system to automate any, or all, of the process steps. One skilled in the art will recognize that a complete commercial system can include additional sensors, interlocks and controls including a vacuum sensor, a chamber air temperature sensor, a chamber frame temperature sensor, an over-temperature switch, an emergency shut off or “kill” switch, a heat source position interlock, and keyswitch lockout control to facilitate system operation and personnel safety. One skilled in the art will further recognize that the control system can be implemented, or controlled by, a suitably programmed general purpose computing system. The programmed general purpose computing system can include the computing system used to acquire, store and print decorative images.

The types of articles that can be decorated by the presently-claimed invention are numerous and varied. Materials which can be decorated by the presently-claimed invention include metals, plastics, bamboo, wood, glass, and metals wherein such materials can also be pre-coated. Some typical examples articles which can be decorated include decorating parts of well-known electronics devices including cell phones, digital music players, laptop computers, decorative car parts, kitchen appliances, tiles, and lamp bases. The systems of the presently-claimed invention are well-suited to producing decorated articles in a manufacturing process, or as a separate after-market customization service. In a manufacturing process, a manufacturer can receive orders for customized decoration and divert a portion of their manufacturing product line output to a decorative customization line where certain parts are decorated, and the finished article is then delivered to a retailer or end customer. In an after-market customization process, a customer can bring an article to be decorated to a shop where it is disassembled, a part or parts can be decorated per customer requirements, reassembled, and delivered to the customer. In addition, third-party parts suppliers can order unfinished parts from a manufacture to be decorated in accordance with custom orders, decorate the parts, and ship the decorated parts back to the manufacturer, to a customization house, or to an end user. Further, the systems and methods for creating a decorating film can be entirely separate from the systems and methods for decorating an article of manufacture. For example, one vendor can specialize in taking customer orders for, and creating, decorating film media and another vendor can specialize in using the decorating film media obtained from the first vendor to decorate articles.

In one aspect, a method of decorating an article by diffusion comprises placing the article to be decorated into a chamber having a support for the article, placing a decorating film having a decorative image comprising diffusion ink onto a face of the article to be decorated, securing the decorating film to the chamber, and heating the chamber to a selected temperature for a selected time. In some embodiments, the decorating film is removed after heating the chamber. In some embodiments the process further comprises securing the decorating film to the chamber in an air-tight manner, and changing the air pressure within the chamber. In some embodiments, heating the chamber to a selected temperature comprises heating the chamber to a temperature in the range of 120° C. to 300° C. In some embodiments, heating the chamber for a selected time comprises heating for a time in the range of 5 minutes to 45 minutes.

In another aspect, a method of creating a decorating film having a decorative image comprises acquiring the decorative image to be used in decorating the article, and imprinting the decorative image onto a blank decorating film with diffusion ink, thereby creating a decorating film having a decorative image. In some embodiments, acquiring a decorative image comprises digitally acquiring the decorative image. In some embodiments, digitally acquiring the decorative image comprises receiving the decorative image as a file via a network. In some embodiments, the network is the Internet, a cellular network, a packet switched network, an intranet, a local area network, or a public switched telephone network. In some embodiments, imprinting the decorative image comprises imprinting using diffusion ink, and in some embodiments imprinting the decorative image comprises usage of multiple colors of ink. In some embodiments, imprinting the decorative image onto a decorating film comprises printing using a dye diffusion ink printer.

In yet another aspect, a machine for transferring a decorative image on a decorating film to an article to be decorated comprises a chamber having a support for receiving the article, means for securing the decorating film position in relation to the article to be decorated, and a heat source, removably thermally coupled to the chamber. In some embodiments, means for securing the decorating film to the chamber can comprise an air-tight connection of the decorating film to the chamber. In some embodiments, the machine further comprises a vacuum source coupled to the chamber. In some embodiments, the machine further comprises a heat removal system coupled to the chamber.

In still another embodiment, a system for transferring a decorative image onto an article to be decorated comprises a computing system coupled to a network, a scanner, and a printer in communication with the computing system, wherein the printer is loaded with a decorating film and a supply of ink, and a machine for transferring a decorative image on a decorating film to an article to be decorated. The machine includes a chamber having a support for receiving the article, means for securing the decorating film to the chamber, in a fixed position in relation to the article to be decorated, a heat source removably coupled to the chamber, and a vacuum source coupled to the chamber. In some embodiments, means for securing the decorating film to the chamber comprise a substantially air-tight seal. In some embodiments, the system is coupled to a network wherein the network is one from the group consisting of the Internet, a cellular network, a packet switched network, an intranet, a local area network, and a public switched telephone network.

In another aspect a method of applying a decorating film to a substrate is practiced in a chamber containing the substrate and the decorating film, the decorating film defining a first sub-chamber and a second-sub-chamber within the chamber, each coupled to a vacuum source, the chamber comprising a heating source. The method comprises heating the chamber to a first temperature; applying a vacuum to both the first and second sub-chambers; stopping the vacuum to the first sub-chamber; and applying a compressed air source to the first sub-chamber. In a preferred embodiment, heating the chamber comprises applying at least one of a plurality of heat sources to the chamber. Preferably, one of the plurality of heat sources comprises an infra-red heat source. The method preferably further comprises heating the chamber at a second temperature after stopping the vacuum to the first sub-chamber. The method can also comprise an optional step of cooling the chamber. In a preferred embodiment, the method comprises maintaining the heating of the chamber at the second temperature for a pre-determined period of time. The method can also comprise a step of removing the decorating film from the substrate, comprising stopping the application of compressed air to first sub-chamber; and applying a vacuum to the first sub-chamber. Removal can be enhanced by applying compressed air to the second sub-chamber.

A system for applying a decorating film to a substrate comprises a chamber configured to receive a substrate and a decorating film, the decorating film defining a first sub-chamber and a second sub-chamber within the chamber; a vacuum source coupled to each of the first and second sub-chamber; a compressed air source coupled to at least the first sub-chamber; and a heating source coupled to the chamber. Preferably, the heating source comprises a plurality of heating element types. In another preferred embodiment, the plurality of heating element types comprises an infra-red heating element. The system can further comprise a control system configured to control heating of the chamber; control application of the vacuum source to each of the first and second sub-chamber; and control application of compressed air to at least the first sub-chamber. The control system is preferably further configured to heat the chamber at a first temperature; apply vacuum to each of the first sub-chamber and second sub-chamber; then stop the vacuum to the first sub-chamber and apply compressed air to the first sub-chamber; and heat the chamber to a second temperature. In another preferred embodiment, the control system is further configured to maintain the heating of the chamber at the second temperature for a pre-determined period of time. The control system can further be configured to apply a vacuum to the first sub-chamber. The system can further be configured to perform removal of a decorating film from a substrate. The system comprises a compressed air source coupled to the second sub-chamber. The control system is further configured to apply the compressed air to the second sub-chamber. In another embodiment, the control system is further configured to cool the chamber. Preferably, the system further comprises a compressed air source coupled to the second sub-chamber, wherein cooling the chamber comprises the application of compressed air and vacuum to at least one of the first sub-chamber and the second sub-chamber, thereby flowing a cooling air flow within the at least one sub-chamber.

In yet another embodiment, a non-transitory computer readable medium comprising processor executable instructions that, when executed, implement any of the above methods.

### BRIEF DESCRIPTION OF THE DRAWINGS:

FIG. 1 illustrates a diagram of a system for transferring a decorative image to an article to be decorated according some embodiments.

FIG. 2A illustrates a diagram of a chamber of a machine for transferring a decorative image on a decorating film to an article to be decorated according to some embodiments.

FIG. 2B illustrates a diagram of a section view of the inside of a chamber of a machine for transferring a decorative image on a decorating film to an article to be decorated according to some embodiments.

FIG. 2C illustrates a diagram of the support for an article to be decorated with the article to be decorated according to some embodiments.

FIG. 2D illustrates a diagram of the chamber of a machine for transferring a decorative image on a decorating film to an article to be decorated, including the decorating film and the retaining frame, according to some embodiments.

FIG. 2E illustrates a diagram of an assembled chamber of a machine for transferring a decorative image on a decorating film to an article to be decorated, according to some embodiments.

FIG. 2F illustrates a diagram of a finished article having received a decorative image transferred to the article in accordance with the process described herein, in some embodiments.

FIG. 3 illustrates a diagram of the internal components of a machine for transferring a decorative image on a decorating film to an article to be decorated according to some embodiments.

FIG. 4 illustrates a diagram of the steps of a method of preparing an article for transferring a decorative image to the article according to some embodiments.

FIG. 5 illustrates a diagram of the steps of a method of transferring a decorative image to an article according to some embodiments.

FIG. 6 illustrates a decorating chamber according to some embodiments.

FIG. 7 illustrates a decorating chamber comprising a heating source according to some embodiments.

FIG. 8 illustrates a decorating chamber comprising a heating source and a vacuum source according to some embodiments.

FIG. 9 illustrates a system for decorating a substrate according to some embodiments.

FIG. 10 illustrates a system for decorating a substrate according to some embodiments.

FIG. 11 illustrates a system for decorating a substrate according to some embodiments.

FIG. 12 shows the steps of a method of applying a decorating film to a substrate according to some embodiments.

FIG. 13 shows the steps of a method cooling a substrate that has been decorated according to the processes described herein.

FIG. 14 shows the steps of a method of removing a decorating film from a substrate according to some embodiments.

FIG. 15 illustrates a control system of a system for decorating a substrate according to some embodiments.

### DETAILED DESCRIPTION OF THE DRAWINGS

Embodiments of the present application are directed to systems and methods for transferring a decorative image to an article to be decorated. One of ordinary skill in the art will recognize that the specific embodiments disclosed are illustrative, and not to be construed as limiting in any way. It will be appreciated that numerous implementation-specific decisions must be made in order to comply with applicable regulatory and safety requirements, business requirements and design-specific goals and that such design nuances would be a well within the knowledge of one of ordinary skill who routinely designs within such constraints.

A system for transferring a decorative image to an article to be decorated according to the presently-claimed invention enables a manufacturer, an after-market customizer or an end user to decorate one or more parts of an article so as to personalize the article. For example, a person may want to decorate their laptop computer case with a picture of their family, or a cell phone cover with an image that they developed from original art. Such decorations personalize an article so that it is more easily distinguished from the numerous other like units on the market. Thus, a system for transferring a decorative image to an article to be decorated first includes means to acquire an image. Such means include obtaining the image from a list of stored images which a vendor may offer, uploading a personalized image as a part of a decoration order by a customer, downloading images from a network such as the Internet, transferring images from a camera, capturing a frame of video from a video camera, and scanning an image with a scanner. Once the image is acquired, the image is printed onto a blank decorating film by a diffusion ink printer, producing a decorating film. A machine which uses the decorating film includes a chamber for holding the article which is to be decorated and the decorating film, a heat source, and a vacuum source. A mount is made or selected for the specific part which is to be decorated. When the article to be decorated is mounted on the mount, and the mount is placed in the chamber, the surface to be decorated is substantially parallel to, and can protrude slightly out of, an opening in the chamber. The decorating film is placed, ink down, onto the surface to be decorated, and a retaining frame is placed over the decorating film and onto the chamber, fixing the relative positions of the chamber, the article, and the decorating film. The decorating film effectively separates the chamber into a first sub-chamber and a second sub-chamber. An independently controllable vacuum source and a compressed air source are coupled to each of the first and second sub-chambers. The chamber is mounted to the machine and a heat source is brought down in contact, or nearly in contact, with the decorating film. A heat cycle is started, and is followed by an optional cooling cycle. During a pre-heating process, vacuum is applied to both the first and second sub-chambers. Then compressed air is applied to the first sub-chamber to exert a force on the decorating film, urging it onto the substrate. The pre-heat process softens the decorating film, allowing it to apply uniformly to the substrate. During the heat cycle, the diffusion ink is transferred from the decorating film to the surface of the article to be decorated, diffusing the ink into the surface of the article to be decorated, and then at least partially heat-cured to stabilize the transferred image. The heat source is then removed from the chamber or turned OFF. A optional cooling process operates by applying compressed air to the first sub-chamber and drawing the resulting heated air out of the first sub-chamber by application of vacuum. In a second optional process, the used decorating film can be removed from the substrate by applying compressed air to the second sub-chamber and applying a vacuum to the first sub-chamber, causing the decorating film to lift off of the substrate. The chamber is removed from the machine, the retaining frame is removed from the chamber, the used decorating film is discarded or recycled, and the finished part is removed from the chamber. In some embodiments, the chamber is a fixed part of the machine which is not removed and replaced.

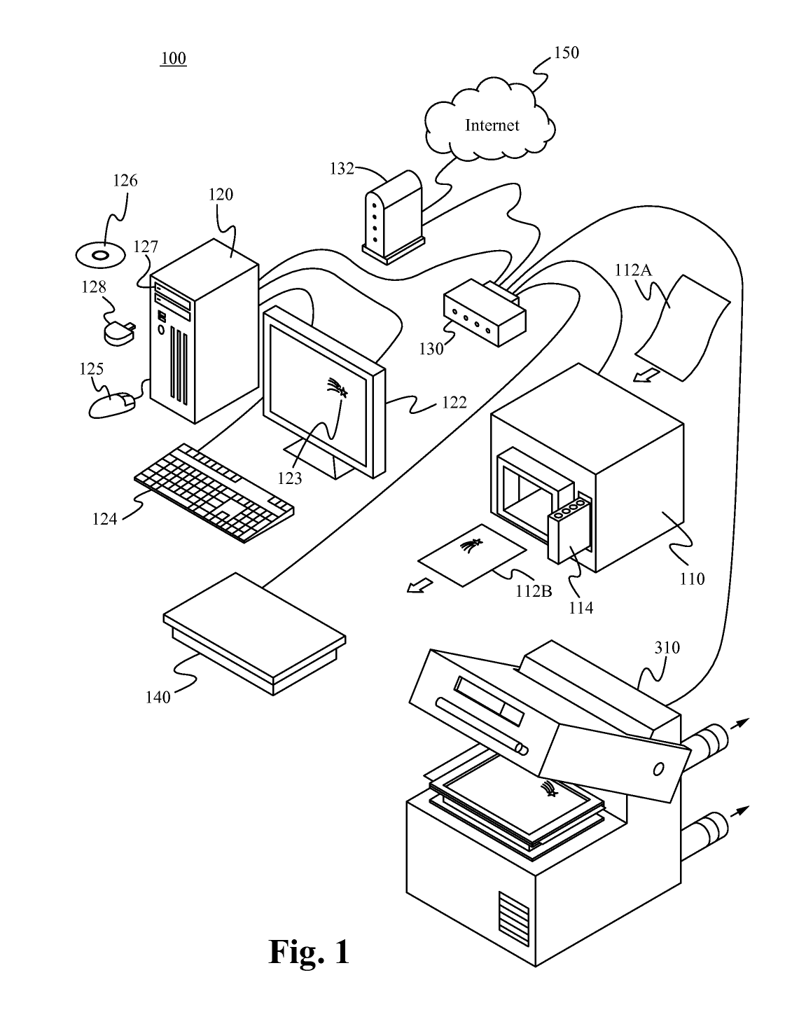

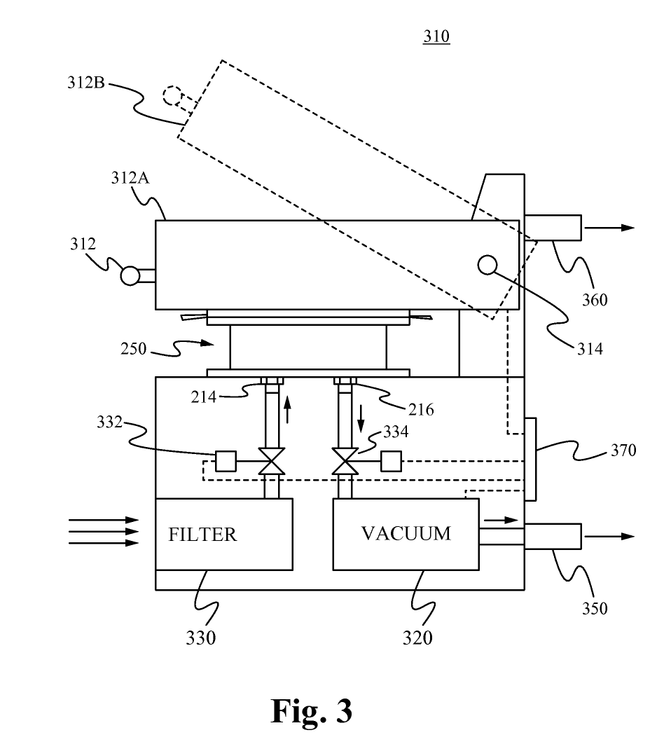

FIG. 1 illustrates a diagram of a system 100 for transferring a decorative image 123 to an article to be decorated according to some embodiments. The system 100 includes a dye diffusion transfer printer 110, a personal computing system 120, a router 130, and a scanner 140. The dye diffusion transfer printer 110 includes dye diffusion ink cartridges 114. The dye diffusion transfer printer 110 receives blank image transfer media 112A, receives the decorative image from the personal computer 120 which is communicatively coupled to the dye diffusion transfer printer 110 via the router 130, and prints the decorative image 123 using the dye diffusion inks 114 to create the decorating film 112B. Alternatively, the dye diffusion transfer printer 110 is able to receive the decorative image from the scanner 140. The personal computer 120 is a conventional computing device and includes a monitor 122, a keyboard 124 and a mouse 125 or other input devices known in the art. The personal computer 120 is communicatively coupled to the scanner 140, the dye diffusion transfer printer 110 and the network 150 via the router 130. The router 130 is further able to be coupled to the network 150 via a cable modem 132 or like communication device. The personal computer 120 is able to receive the decorative image 123 from the scanner 140, a portable storage medium such as a flash memory stick 128, a CD-ROM 126, a local hard drive 127, or via the network 150 by direct customer uploading, via email as an attachment, or other network transfer means. The system 100 further comprises a machine 310 for transferring a decorative image 123 on a decorating film 112B to an article to be decorated (not shown), as further described in FIG. 3.

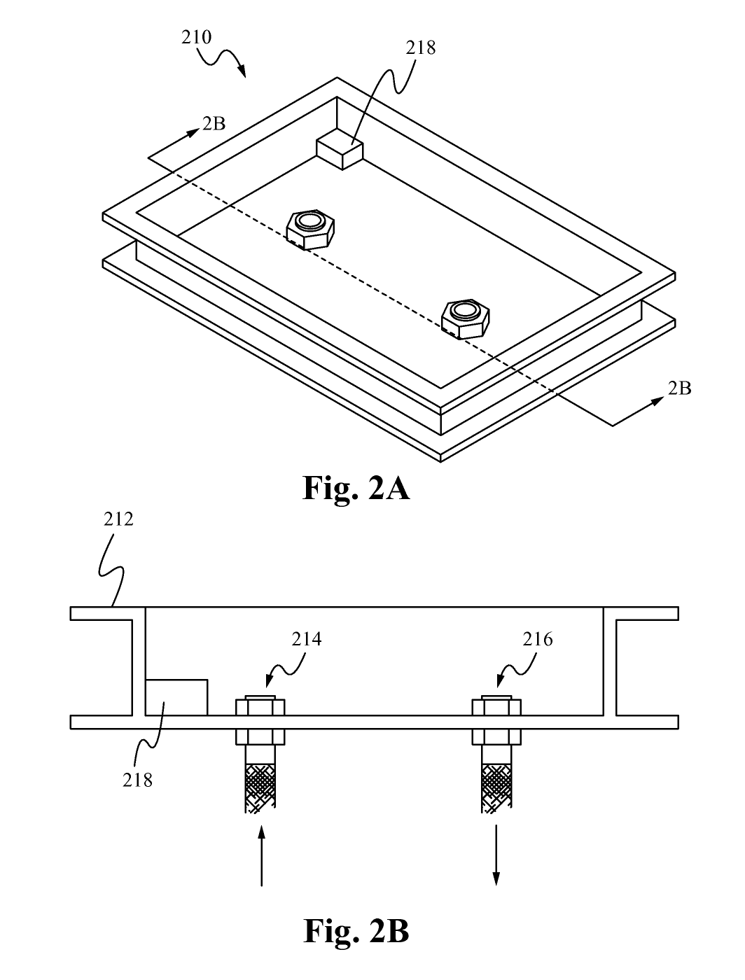

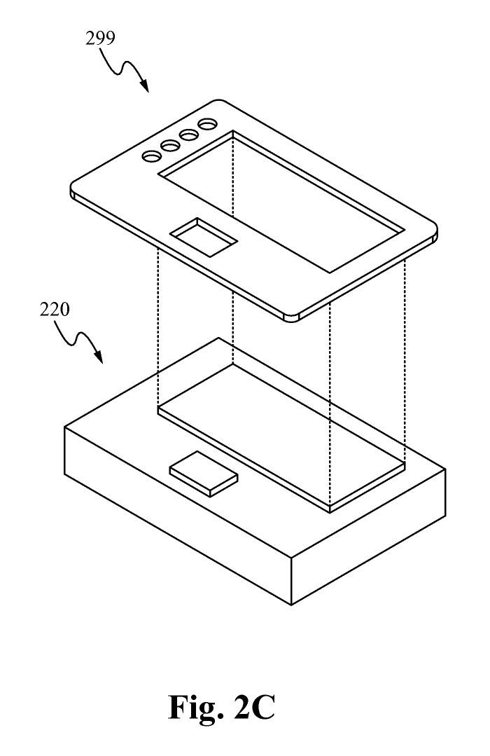

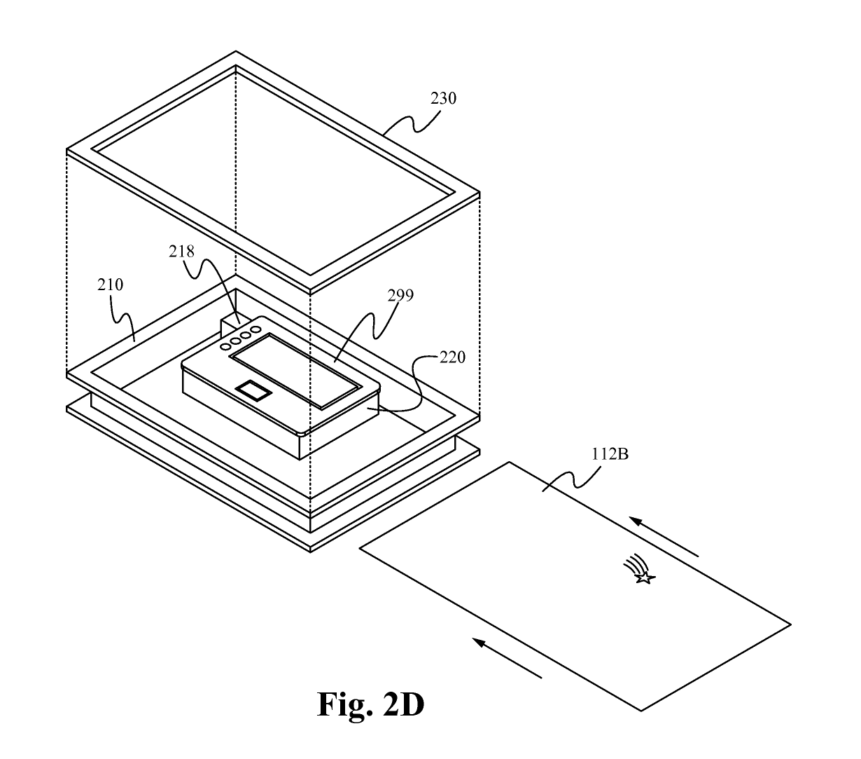

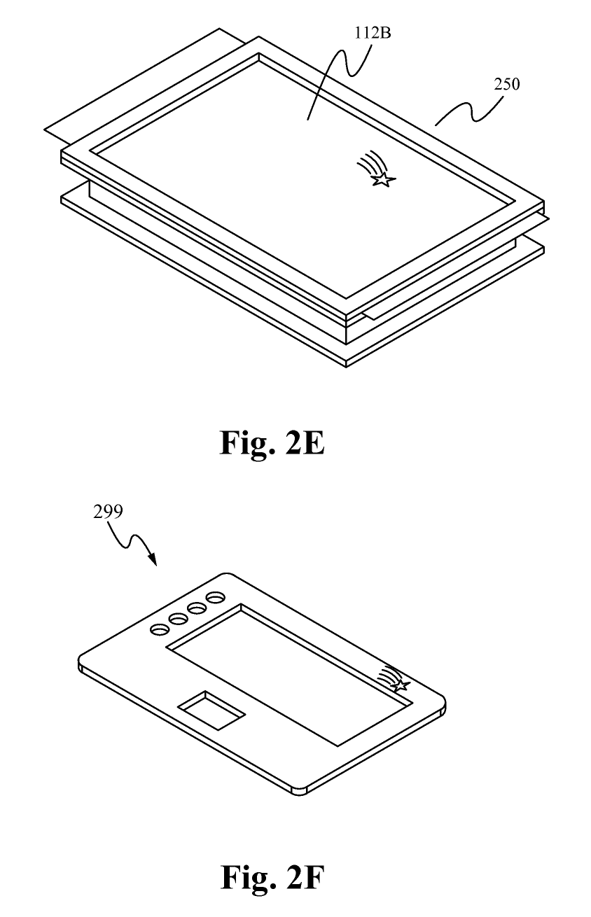

FIG. 2A illustrates a diagram of a chamber 210 of the machine 310 (FIGS. 1 and 3) for transferring a decorative image 123 (FIG. 1) on a decorating film 112B (FIG. 1) to an article to be decorated according to some embodiments. FIG. 2B illustrates a diagram of a section view of the inside of a chamber 210 of the machine 310 (FIGS. 1 and 3) for transferring a decorative image on a decorating film to an article to be decorated according to some embodiments. The chamber 210 comprises a flanged frame 212. The flanges on the frame facilitate sealing the chamber 210 with the machine 310, on the bottom side, and a heat source 312 (FIG. 3), on the top side. Details of the internal components of the machine 310 are shown in FIG. 3, described below. In some embodiments, the frame 212 may be flangeless and utilize other known means for sealing the chamber to the machine 310 (FIGS. 1 and 3) and the heat source 312 (FIG. 3) such as specially formed gaskets or 0-rings. In some embodiments, the chamber 210 includes a sensor block 218. In some embodiments the sensor block 218 includes a temperature sensor and a vacuum sensor. The sensor block 218 is able to be interfaced to the control electronics 370, discussed further with respect to FIG. 3, below. In some embodiments, the flanged frame 212 is configured to be coupled to a selectable clean air intake 214 and a selectable vacuum source 216 which are discussed in more detail in FIG. 3, below. The flanged frame 212 is configured to receive a support 220 for an article to be decorated 299 as shown in FIG. 2C.

FIG. 2D illustrates a diagram of the chamber 210 of the machine 310 (FIGS. 1 and 3) for transferring a decorative image on a decorating film 112B to an article to be decorated 299, including the decorating film 112B and a retaining frame 230. The article to be decorated 299 is shown mounted on the support 220 inside of the chamber 210. The support positions the article to be decorated such that the surface of the article to be decorated is substantially parallel with an opening of the chamber. Then, the decorating film 112B containing the decorative image to be transferred is placed over the surface of the article to be decorated 299 with the dye diffusion ink surface of the decorating film 112B directed to contact the surface of the article to be decorated 299. The retaining frame 230 is removably coupled, over the decorating film 112B, to the chamber 210 thereby holding the decorating film tightly over the surface of the article to be decorated 299, and holding the decorating film 112B in a fixed position in relation to the item to be decorated 299 and the chamber 210 by means of the retaining frame 230. The method of coupling the retaining frame 230 to the chamber 210 is substantially air tight for applications where the vacuum source 216 (FIG. 2B) is to be used. The method of coupling can be any suitable mechanical removable coupling means, including but not limited to threaded fasteners, C-clamps or clips, magnetic coupling, or mechanical pressure upon the retaining frame 230.

FIG. 2E illustrates a diagram of an assembled chamber 250 of the machine 310 (FIGS. 1 and 3) for transferring a decorative image on a decorating film 112B to an article to be decorated 299 (FIGS. 2C and 2D). The assembled chamber 250 is able to be mounted on the machine for transferring a decorative image on a decorating film 112B to an article to be decorated 299. In some embodiments, the chamber 210 (FIGS. 2A, 2B, and 3) is permanently fixed to the machine 310.

FIG. 2F illustrates a diagram of a finished article 299 having received the decorative image transferred to the article in accordance with the process described herein, in some embodiments.

FIG. 3 illustrates a diagram of the internal components of a machine 310 for transferring a decorative image on a decorating film 112B to an article to be decorated 299 according to some embodiments. The assembled chamber 250 is removably coupled to the machine 310. If the clean air source 214 and/or vacuum source 216 are to be used, then the assembled chamber 250 is removably coupled to them on the machine 310. In some embodiments, the chamber 210 (FIG. 2D) is permanently coupled to the machine 310, and the mount 220 (FIG. 2D), the article to be decorated 299 (FIG. 2D), the decorating film 112B (FIG. 2D) and the retaining frame 230 (FIG. 2D) are assembled onto the permanently coupled chamber 210 (FIG. 2D) to form the assembled chamber 250. In embodiments where the chamber 210 (FIG. 2D) is permanently coupled to the machine 310, the clean air source 214 and the vacuum source 216 are also permanently coupled to the chamber 210, for convenience. One skilled in the art would recognize that the clean air intake 214 and vacuum intake 216 can also alternatively also be removably coupled (not shown) to the chamber 210. The lower housing of the machine 310 can comprise a clean air intake filter 330 for drawing cooling air to the assembled chamber 250. An air intake valve 332 is able to be closed to retain the heat inside the assembled chamber 250 during heating, and to maintain a vacuum in the assembled chamber 250 in the event that the vacuum source 216 is used. A vacuum pump 320 is able to draw a vacuum on the chamber 250 in order improve the physical contact between the decorating film 112B (FIG. 1) and the article to be decorated 299 in the chamber 250. The vacuum inside of the chamber effectively pulls the decorating film 112B more tightly against the mounted article to be decorated 299 than ambient air pressure, thereby improving the transfer of diffusing inks into the surface to be decorated. If the vacuum source 216 is to be used, the air intake valve 332 is closed, a vacuum valve 334 is opened, the vacuum pump 320 is turned on, and a vacuum is created within the assembled chamber 250. When the desired level of vacuum is achieved, the vacuum pump 320 is able to be turned off or throttled back to maintain the vacuum in the chamber 250. The vacuum pump 320 is able to exhaust the air removed from the assembled chamber 250 out through a vacuum exhaust 350 by opening the air intake valve 332, which draws cool air from outside the machine 310, into the filter 330, through the open valve 332, into the chamber 250 via connection 214, and out through the vacuum connection 216, vacuum valve 334, into vacuum pump 320 and out the vacuum exhaust 350, thereby speeding the cooling of the chamber and the article being decorated.

After the assembled chamber 250 is removably coupled to the machine 310, a heat source 312 is lowered from a position 312B down to a position 312A, in close proximity or contact with the assembled chamber 250. In some embodiments, the heat source 312 is rotatably coupled to the machine 310 at a point 314, to facilitate positioning of the heat source 312. The heat source 312 can be any conventional heat source such as an electrical heater, gas heater, microwave, laser, infrared lamp, or other heat generating device. The heat source 312 initiates a heat cycle wherein the heat source is brought to a selected temperature for a selected time, depending upon the article to be decorated 299 within the assembled chamber 250. In some embodiments, the heat source 312 is able to be locked into the position 312A during the heating cycle for personnel safety. A heat cycle releases the diffusion inks from the decorating film 112B to the surface of the article to be decorated 299, diffusing the ink into the surface of the article to be decorated 299. At the completion of the heat cycle, hot air within the heat source 312 is able to be exhausted out of a heat exhaust 360. In some embodiments, the clean air intake valve 332, the vacuum source valve 334, the vacuum pump 320 and the heat source 312 are interfaced to an electronics control interface 370. The electronics control interface 370 is able to be interfaced to a personal computer 120 (FIG. 1), either directly or via a router 130 (FIG. 1), for the purpose of automating the operation of the machine 310. Automating the operation of the machine 310 includes the computer 120 setting the heat cycle parameters, time and temperature, the vacuum requirements, if any, sensing of the heat source position, 312A or 312B, locking and unlocking the heat source 312 in a position, detecting the heat source position and lock status before starting the heat cycle, and sensing the temperature within the assembled chamber 250 and the heat source 312.

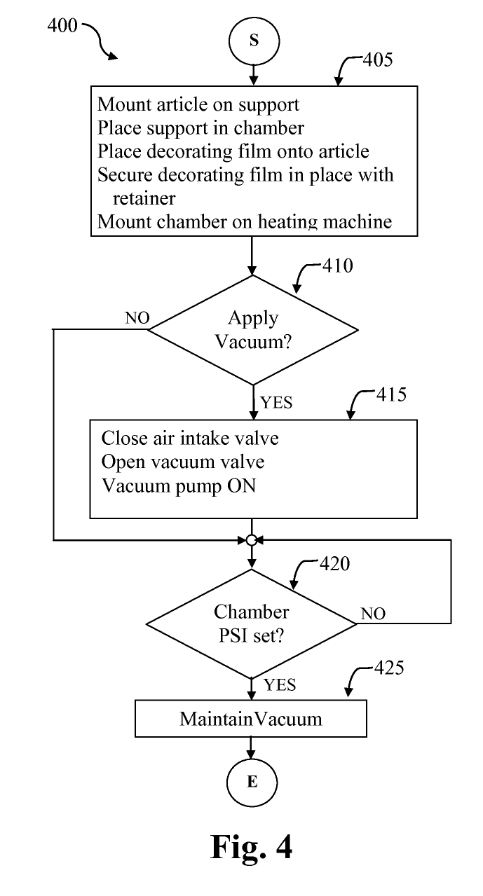

FIG. 4 illustrates a diagram of the steps a method 400 for preparing an article for transferring a decorative image to an article. At step 405, the article to be decorated 299 (FIG. 2C and 2D) is mounted on a support 220 (FIG. 2C), and the support 220 and article 299 are placed inside the chamber 210 (FIG. 2D). A decorating film 112B (FIG. 2D) is then positioned over the article 299 to be decorated, with the dye diffusion ink side of the decorating film facing the article to be decorated. A retaining frame 230 (FIG. 2D) is secured to the chamber 210 (FIG. 2D), thereby holding the decorating film 112B in a fixed position relative to the chamber frame and the support and article to be decorated, inside the assembled chamber. At step 410, if the vacuum source 320 (FIG. 3) is to be used, then at step 415 the clean air intake valve 332 (FIG. 3) is closed, the vacuum source valve 334 (FIG. 3) is opened, and the vacuum source 320 is turned on until a set vacuum pressure is achieved. If the set vacuum pressure is achieved at step 420, then at step 425 the vacuum source 320 is turned off or throttled back to maintain the set vacuum pressure.

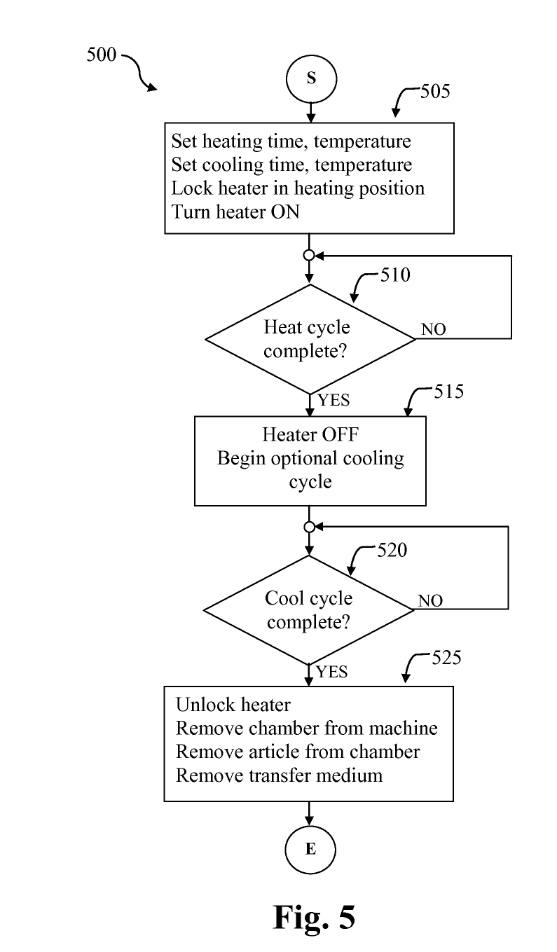

FIG. 5 illustrates a diagram of the steps of a method 500 of transferring a decorative image to an article. At step 505, a heating cycle time and temperature are set, an optional cooling cycle time and ending temperature are set, the heater 312 (FIG. 3) is locked into the heating position and the heat source 312 is turned on, starting the heat cycle. When the heat cycle is completed, at step 510, then the heat source 312 is turned off at step 515. The heat cycle is complete when the selected temperature has been applied to the chamber for the set time. Alternatively, the heat cycle is able to be completed by manual interruption (not shown). After the heat cycle is complete the optional cooling cycle begins. The cooling cycle can be a preset time which for which the heat source 312 is off but the heat source cannot be raised to remove the assembled chamber 250 (FIG. 3). After the heat source 312 is off, the cooling cycle can further be a temperature set point to which the assembled chamber 250 must drop before the heat source 312 can be raised to remove the assembled chamber 250. The cooling cycle can further include opening the air intake valve 332 (FIG. 3), opening the vacuum valve 334 (FIG. 3), and turning on the vacuum pump 320 (FIG. 3) to draw cool air into assembled chamber 250. Alternatively, the cooling cycle can be any combination of the above described cooling cycles. When the cooling cycle is complete at step 520, then at step 525 the heater 312 is unlocked from its heating position, the chamber 250 (FIG. 2D) is removed from the machine 310 (FIG. 3) for transferring a decorative image to an article, the article is removed from the chamber, and the used decorating film is removed from the article to be decorated. The cooling cycle is completed when the chamber temperature has been at, or below, a selected temperature for a selected period of time. Alternatively, the cooling cycle is able to be completed by manual interruption. In some embodiments, the cooling cycle is optional. Setting the cooling time to zero, or setting the cooling temperature to a value above the heat cycle temperature, are examples of ways to logically render the cooling cycle optional. Embodiments using the personal computer 120 (FIG. 1) to automate the decorating film process can utilize other methods to make the cooling cycle optional such as unlocking the heat source 312 from the chamber 250 after completion of the heating cycle.

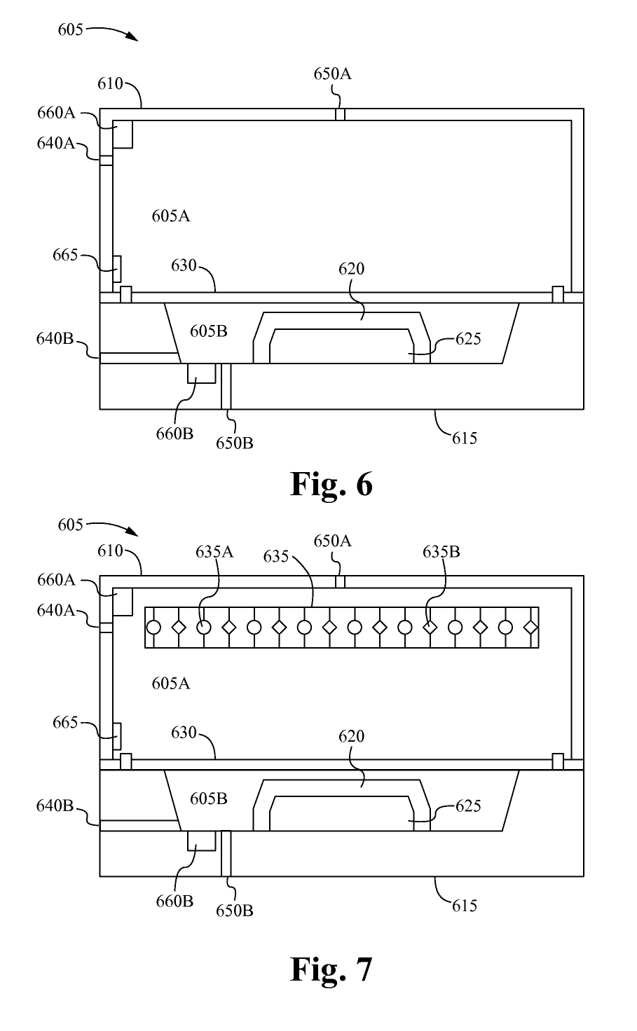

FIG. 6 illustrates a decorating chamber 605 according to some embodiments. The chamber 605 formed by a chamber cover 610 and a chamber platen 615. A substrate 620 to be decorated is mounted on a substrate support 625 inside of the chamber 605, preferably on the platen 615. A decorating film 630 is mounted to the chamber platen 615 and the chamber cover 610 is secured to the chamber platen 615. The decorating film 630 separates the chamber 605 into a first sub-chamber 605A and a second sub-chamber 605B. The chamber cover 605 has an opening for a first sub-chamber compressed air source 650A that is pneumatically coupled to the first sub-chamber 605A. The chamber cover 605 also has an opening for a first sub-chamber vacuum source 640A that is pneumatically coupled to the first sub-chamber 605A. The chamber platen 615 has a opening for a second sub-chamber vacuum source 640B that is pneumatically coupled to the second sub-chamber 605B. Optionally, the chamber platen 615 also has an opening for a second sub-chamber compressed air source 650B that is pneumatically coupled to the second sub-chamber 605B. The chamber cover 610 comprises a first sub-chamber pressure/vacuum sensor 660A and a temperature sensor 665. The chamber platen 615 comprises a second sub-chamber pressure/vacuum sensor 660B.

FIG. 7 illustrates a decorating chamber 605 as shown in FIG. 6 and further comprising a heating source 635. The heating source 635 comprises a first heating element type 635A and a second heating element type 635B. Each of the first and second heating element types 635A and 635B, respectively, can comprise an infra-read heating source, an LED, a laser medium, a light bulb, heated air source such as a gas-fired furnace, or a wire-resistance heat source. The first and second heat generating elements 635A and 635B are preferably each independently controllable. In some embodiments, the first and second heat generating elements 635A and 635B comprise different heating generating components. A temperature sensor 660 is preferably located to sense inside the first sub-chamber 605A. Preferably, the temperature sensor 660 is located close to the decorating film 630 to determine temperature of the first sub-chamber 605A near the decorating film 630.

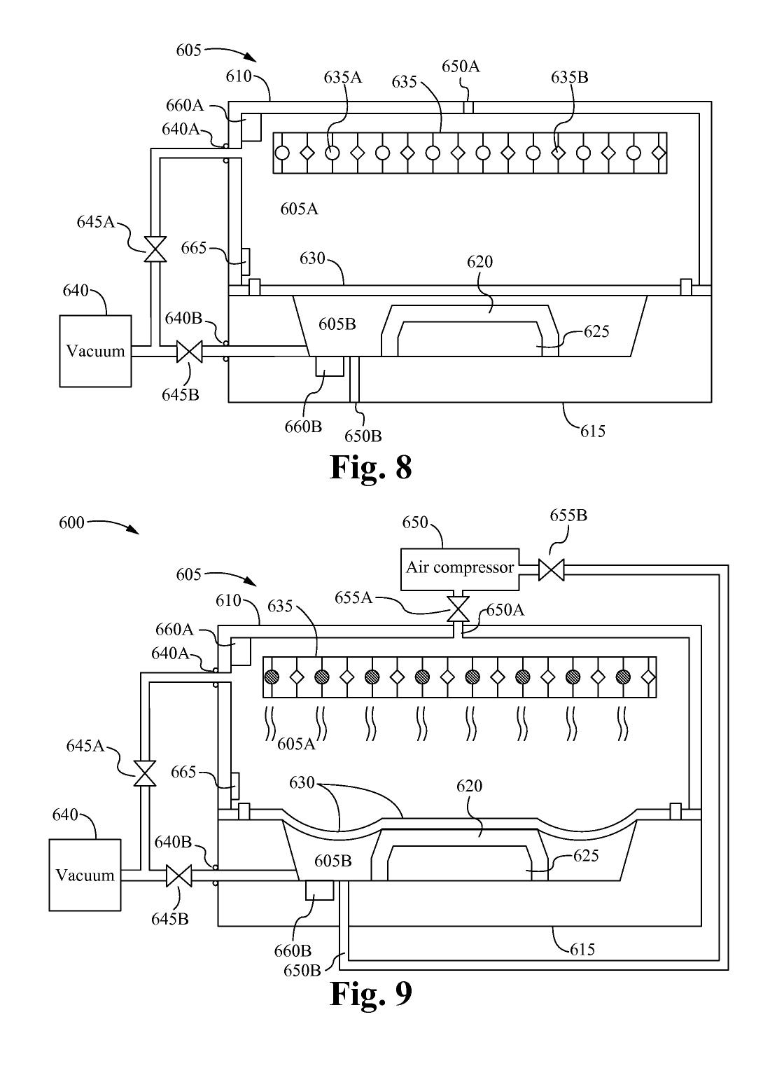

FIG. 8 illustrates the decorating chamber 605 comprising a heating source 635 of FIG. 7 and further comprising a vacuum source 640. The vacuum source 640 branches into two vacuum source points, each preferably independently controllable by a vacuum source control valve. The application of vacuum to the first sub-chamber 605A at a first sub-chamber vacuum source point 640A is controlled by the operating state of the vacuum source 640 and the first sub-chamber vacuum source control valve 645A. The application of vacuum to the second sub-chamber 605B at a second sub-chamber vacuum source point 640B is controlled by the operating state of the vacuum source 640 and the second sub-chamber vacuum source control valve 645B. One skilled in the art will recognize that the first sub-chamber vacuum source point 640A could be coupled to the chamber cover 610, and thereby the first sub-chamber 605A, at a variety of locations to implement the claimed functionality. Similarly, the second sub-chamber vacuum source point 640B could be coupled to the chamber platen 615, and thereby to the second sub-chamber 605B, at a variety of locations to implement the claimed functionality. Preferably, the second sub-chamber vacuum source point 640B is located at or near the lowest area within the second sub-chamber such that the decorating film does not obstruct the application of vacuum to the second sub-chamber 605B as the decorating film 630 is drawn down over the substrate 620 by the application of vacuum to the second sub-chamber 640B. As shown in FIG. 8, the first heating element type 635A is turned on at a first temperature. This softens the decorating film 630. The vacuum source 640 is turned on, the first sub-chamber vacuum source control 645A is opened, and the second sub-chamber vacuum source control 645B is opened, thereby evacuating air from the first and second sub-chambers. The first and second sub-chamber vacuum source controls 645A and 645B, respectively, are operable to independently control the vacuum level of the first and second sub-chambers 605A and 605B, respectively, such that the vacuum level in the second sub-chamber 605B is able to be greater than the vacuum level in the first sub-chamber 605A. Additional controls and valves, such as check valves and pressure regulating valves can be used to accomplish such control.

FIG. 9 illustrates a system 600 for decorating a substrate 620 as shown in FIG. 8 and further comprising a compressed air source 650. The compressed air course 650 is able to be an air compressor, with our without an air receiver, a pressurized tank of a gas such as argon, or a high-speed fan or other air moving device of appropriate volume and pressure. The pressure and volume of compressed air delivered by the compressed air source 650 can be variable over a range, ON/OFF, pulsed, or a combination of these. The compressed air source 650 is split into two separate branches. The first branch supplies compressed air to the first sub-chamber 605A at a first sub-chamber compressed air source point 650A, controllable by a first sub-chamber compressed air source control valve 655A. The second branch supplies compressed air to the second sub-chamber 605B at a second sub-chamber compressed air source point 650B, controllable by a second sub-chamber compressed air source control valve 655B. As shown in FIG. 9, a first heating element type 635A is heated to a first temperature. The heat softens the decorating film 630 but the heat is held sufficiently low to avoid substantial transfer of the graphic on the decorating film 630 to the substrate 620. The first sub-chamber vacuum source control 645A is closed to stop application of vacuum to the first sub-chamber 605A. The compressed air source 650 is then applied to the first sub-chamber 605A at the first sub-chamber compressed air source 650A using the first sub-chamber compressed air source control 655A. The application of compressed air to the first sub-chamber 605A exerts a pressure upon the decorating film 630. The combination of the positive pressure within the first sub-chamber 605A generated by the application of compressed air, along with the vacuum within the second sub-chamber 605B at the second sub-chamber vacuum source point 640B, causes the decorating film 630 to deflect downward into the second sub-chamber 605B, thereby urging the decorating film 630 into contact with the substrate 620. The downward force upon the decorating film 630 acts to pull the decorating film 630 outward, across the top of the substrate 620 in a manner that reduces the formation of wrinkles within the decorating film 630. At this time, the second sub-chamber compressed air source control 655B is closed such that there is no application of compressed air to the second sub-chamber 605B.

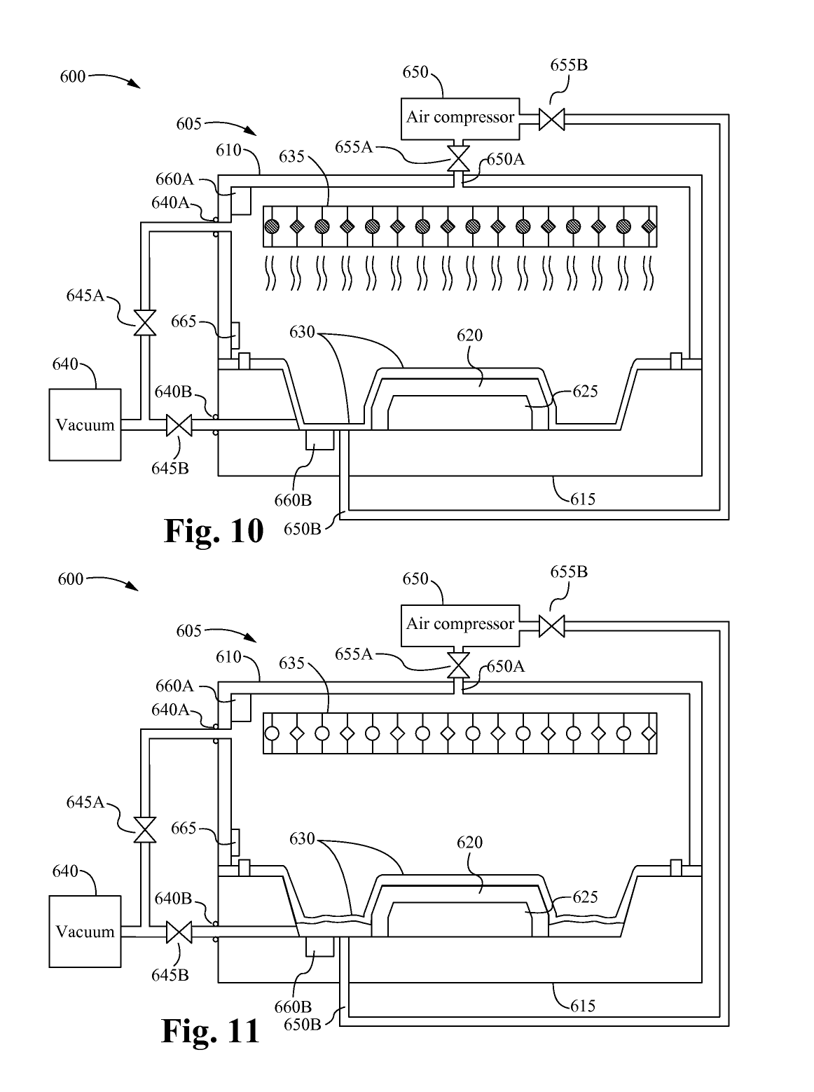

FIG. 10 illustrates a system 600 for decorating a substrate 620 as shown in FIG. 9 wherein the second sub-chamber 605B has been substantially collapsed. The second sub-chamber has been collapsed by voiding of the air in the second sub-chamber 605B due to the application of compressed air to the first sub-chamber 605A and the application of vacuum to the second sub-chamber 605B. With the decorating film 630 substantially applied to the substrate 620, the second heating element type 635B is activated to a second temperature. One skilled in the art will recognize that the first and second heating element types 635A and 635B, respectively, can be the same type. The atmospheric pressure within the first sub-chamber 605A is maintained so that a force is applied to the decorating film 630, urging the film to the substrate 620. One skilled in the art will recognize that heating of first sub-chamber 605A can cause the atmospheric pressure within the first sub-chamber 605A to rise in relation to the temperature within the chamber 605. Accordingly, the compressed air source 650 can be modulated or attenuated to prevent an excessive pressure build-up within the chamber 605, either through direct control of the compressed air source 650 or through use of the first sub-chamber compressed air source control 655A. Further, the first sub-chamber vacuum source control 645A can be used to reduce the atmospheric pressure within the first sub-chamber 605A as needed.

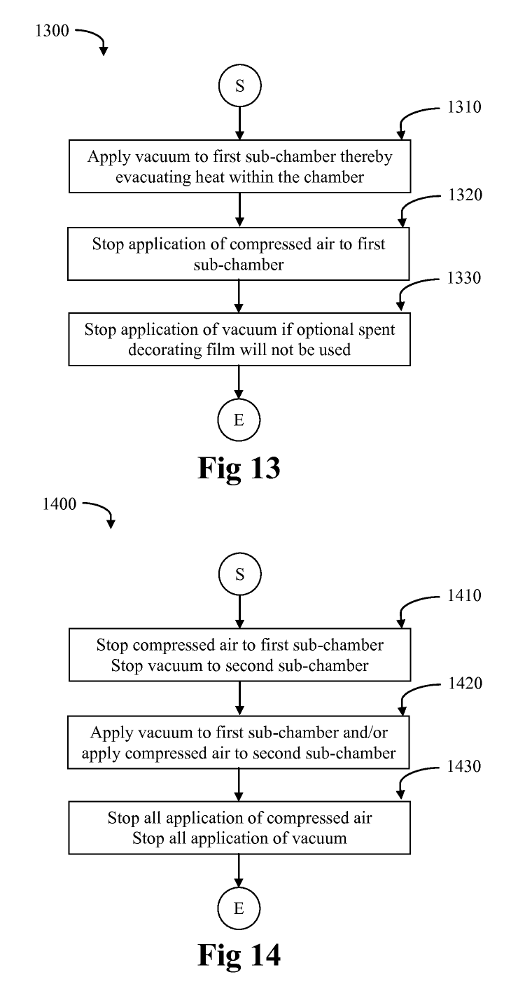

FIG. 11 illustrates a system 600 for decorating a substrate 620 as shown in FIG. 10, after the graphic on the decorating film 630 has been transferred to the substrate 620. In FIG. 11, the first and second heating element types 635A and 635B, respectively, have been turned OFF. An optional cooling process can be carried out before removal of the spent decorating film 630 from the decorated substrate 620. A simple passive cooling process comprises simply waiting for a predetermined time period for cooling to naturally occur. Alternatively, another passive cooling process comprises waiting until a temperature sensor 665 within the first sub-chamber 605A indicates that the temperature has cooled to a predetermined temperature within the first sub-chamber 605A. An active cooling process comprises applying a controlled amount of vacuum to the first sub-chamber 605A while maintaining or increasing the application of compressed air to the first sub-chamber, thereby evacuating heated air from the first sub-chamber 605A. After the optional cooling process is complete, an optional removal process can be carried out to remove the spent decorating film 630 from the decorated substrate 620 as described in FIG. 13, below.

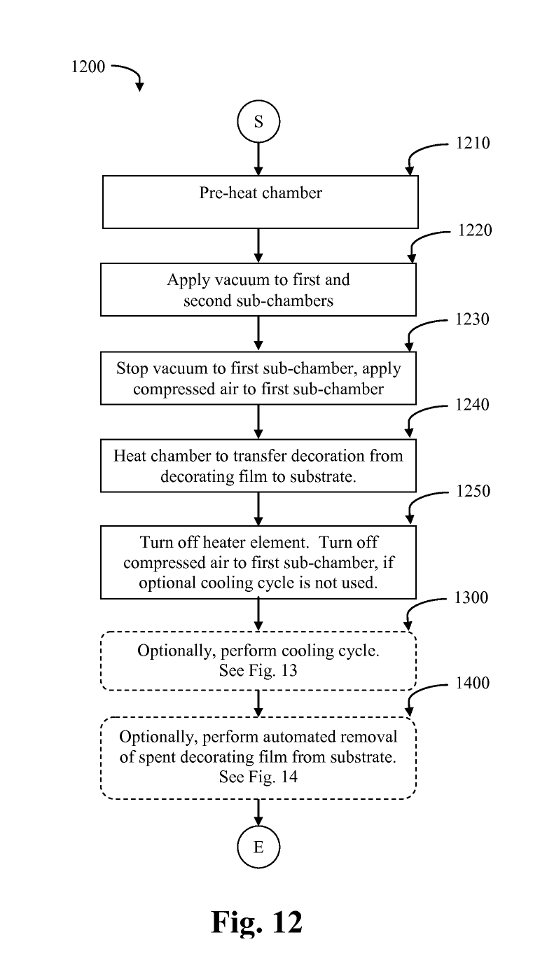

FIG. 12 shows the steps of a method 1200 of applying a decorating film 630 to a substrate 620. Initial set-up steps are not shown in the method 1200. Set-up steps include mounting the substrate 620 to the substrate support 625 within the chamber platen 615, mounting the decorating film 630 to the chamber platen 615, then closing the chamber cover 610 over the chamber platen 615 to form the chamber 605. The chamber 605 is sub-divided into a first and a second sub-chamber 605A and 605B, respectively, by the decorating film 630 mounted to the chamber platen 615. After the initial set-up is complete, the method of applying a decorating file begins. At step 1210 the chamber 605 is pre-heated to a first temperature by turning on the first heating element type 635A. A control system 1500, shown in FIG. 14 below, monitors the temperature within the chamber 605 via a temperature sensor 665 within the chamber 605. The control system 1500 is configured to control the operation of the first heating elements 635A to maintain the first temperature. The pre-heating 1210 of the chamber 605 serves to soften the decorating film 630. At step 1220, the vacuum source 640, in conjunction with the first sub-chamber vacuum source control 645A and second sub-chamber vacuum source control 645B, apply a vacuum to both the first sub-chamber 605A and the second sub-chamber 605B, respectively. Next, at step 1230, the application of vacuum to the first sub-chamber 605A is stopped using the first sub-chamber source control 645A. Compressed air is then applied to the first sub-chamber 605A using the compressed air source 650 in conjunction with the first sub-chamber compressed air source control 655A. During step 1230, the application of vacuum is maintained to the second sub-chamber 605B and compressed air is not applied to the second sub-chamber 605B. Step 1230 is maintained for a predetermined period of time. Alternatively, 1230 is maintained until a predetermined vacuum level is achieved within the chamber 605 as measured by a vacuum and pressure sensor 665A in the first sub-chamber and a vacuum and pressure sensor 665B in the second sub-chamber. At step 1240, the heating source 635 is used to heat the chamber 605 to a second temperature to effect transfer of a graphic on the decorative film 630 to the substrate 620. Either of the first and second heating element types, 635A and 635B respectively, or both, can be used to generate the heat necessary to achieve the second temperature. A temperature sensor 665 monitors the heat within the chamber 605. The temperature sensor 665 and the heating source 635, comprising first and second heating element types 635A and 635B, are interfaced to the control system 1500 to maintain the second temperature within the chamber 605. After a predetermined time, at step 1250 the heating source 635 is turned off. If the optional cooling step described in step 1300 is not used, then the application of compressed air to the first sub-chamber 605 is stopped using the first sub-chamber compressed air source control 655A. The chamber 605, substrate 620, and decorating film 630 be cooled by allowing the heat within the chamber 605 to dissipate passively. Alternatively, an optional cooling cycle can be performed at step 1300, described in FIG. 13 below. After cooling is completed, either passively or by the optional cooling cycle 1300, an optional step 1400, described in FIG. 14 below, can be performed to remove the spent decorating film from the substrate 620. At the completion of the method 1200, the chamber 605 can be opened, the spent decorating film 630 removed from the substrate 620, and the decorated substrate 620 removed from the substrate support 625.

FIG. 13 shows the steps of an optional cooling cycle 1300 that actively cools the chamber 605, substrate 620, and the decorating film 630. In step 1250 of the method described above in FIG. 12, the heating element 635 is turned off. As also described above, if the optional cooling cycle 1300 is not used, then the application of compressed air to the first sub-chamber 605A is stopped. If the optional cooling cycle 1300 is used, then the application of compressed air to the first sub-chamber 605A is maintained. At step 1310, vacuum is applied to the first sub-chamber 605A using the first sub-chamber vacuum source control 645A. The combination of continued application of compressed air to the first sub-chamber 605A and the application of vacuum to the first sub-chamber 605A operates to evacuate heated air within the first sub-chamber 605A, thereby cooling the chamber 605, the substrate 620, and the decorating film 630. One skilled in the art will recognize that a similar effect can be achieved by opening a vent to atmosphere in the chamber cover 610, rather than applying compressed air to the first sub-chamber 605A to achieve a similar cooling effect. Alternatively, a vent to atmosphere in the chamber cover 610 could be used in conjunction with the application of compressed air to the first sub-chamber 605A to force heated air out the vent. The method described in FIG. 13 is preferred over these alternate ways to cool the chamber 605 because heat generated in the practice of the method of FIG. 13 is not vented into the environment in which the method is practiced. At the completion of the cooling step 1310, then at step 1320 the application of compressed air to the first sub-chamber is stopped using the first sub-chamber compressed air source control 655A. At step 1330, the application of vacuum to the first sub-chamber is stopped if the optional automated removal of the decorating film will not be used. Automated removal of the decorating film is described in FIG. 14.

FIG. 14 shows the steps of a method 1400 of removing a decorating film from a substrate according to some embodiments. At step 1410, the application of compressed air to the first sub-chamber 605A is stopped. The application of vacuum to the second sub-chamber 605B is also stopped, thereby stopping the combined forces that were urging the decorating film 630 into contact with the substrate 620. At step 1420, vacuum is applied to the first sub-chamber 605A. Alternatively, or in addition, compressed air is applied to the second sub-chamber 605B. Individually, or in combination, the application of vacuum to the first sub-chamber 605A and application of compressed air to the second sub-chamber 605B serve to urge the spent decorating film 630 off of the substrate 620. At step 1430, application of all compressed air and application of all vacuum is stopped, and the method ends.

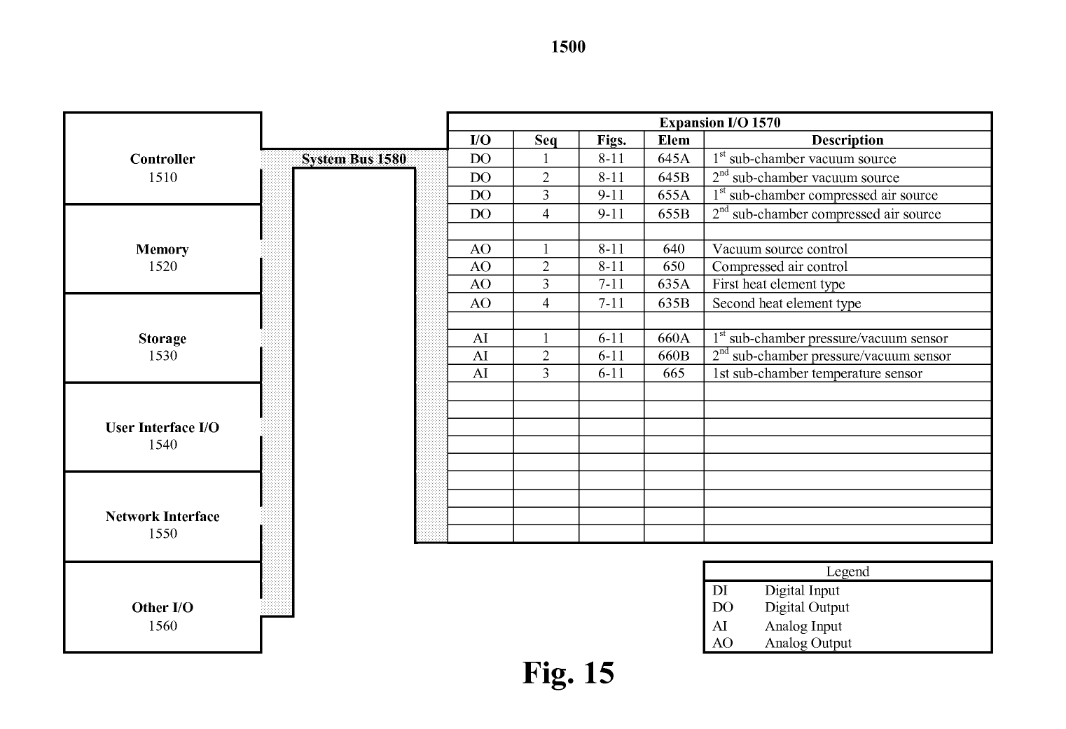

FIG. 15 illustrates a control system 1500 configured to control a system for applying a decorating film to a substrate. The control system 1500 comprises a controller 1510, a memory 1520, storage 1530, a user interface I/O port 1540, a network interface 1550, other I/O 1560, and an expansion I/O module 1570, all communicatively coupled by a system bus 1580. The controller 1510 executes instructions programmed into the storage 1530 and read into the memory 1520. The programmed instructions carry out the method steps 1200 for applying a decorating film to a substrate. In one embodiment, other I/O 1560 comprises interrupt lines, timer/counter inputs and outputs, communications lines such as Clocked Serial I/O, I²C, USB, RS232, RS485, and other communications protocols. The expansion I/O module 1570 comprises analog inputs (AI), analog outputs (AO), digital inputs (DI) and digital outputs (DO). Here, the vacuum source controls 645A and 645 B to the first and second sub-chambers 605A and 605B are interfaced to digital outputs DO-1 and DO-2 respectively. Likewise, the compressed air source controls 655A and 655B to the first and second sub-chambers 605A and 605B are interfaced to digital outputs DO-3 and DO-4 respectively. The controller 1510 sends signals to the appropriate digital outputs in accordance with the method steps 1200 of FIG. 12. One skilled in the art will recognize that these controls could alternatively be implemented as continuously variable control valves interfaced to analog outputs. Also within the expansion IO 1570, the vacuum source 640, compressed air source 650, heating elements of the first type 635A, and heating elements of the second type 635B are controlled by analog outputs AO-1, AO-2, AO-3, and AO-4 respectively. The controller 1510 sends control signals to these analog outputs in accordance with the method steps disclosed herein. One skilled in the art will recognize that these continuously variable controls could each alternatively be interfaced to an interrupt or pulse width modulation port in the Other I/O 1560. The first and second sub-chambers 605A and 605B, respectively, each comprise a combination pressure and vacuum sensor 660A and 660B respectively. The first sub-chamber 605A further comprises a temperature sensor 665. The sensors 660A, 660B, and 665 are each interfaced to an analog input AO-1, AO-2, and AO-3 respectively. The controller 1510 monitors these analog inputs, and their corresponding sensors, in accordance with the method steps disclosed herein. One skilled in the art will recognize that the above control scheme is exemplary only and could be implemented in equivalent, alternative manners.

Operation and control of the heating, compressed air, and vacuum controls is summarized below for each method step.

TABLE 1

| | | 1^{st} | | | 2^{nd} | |
|---|---|---|---|---|---|---|
| Step | | Sub-chamber | | | sub-chamber | |
| # | Description | Heat | Air | Vacuum | Air | Vacuum |
| 1210 | Pre-heat at 1^{st} | ON | OFF | OFF | OFF | OFF |
| | temperature | | | | | |
| 1220 | Vacuum to both sub- | ON | OFF | ON | OFF | ON |
| | chambers | | | | | |
| 1230 | Pressurize 1^{st} | ON | ON | OFF | OFF | ON |
| | sub-chamber | | | | | |
| 1240 | Heat at 2^{nd} temperature | ON | ON | OFF | OFF | ON |
| 1250 | Finish image transfer | OFF | ON | OFF | OFF | ON |
| 1310 | Start optional cooling | OFF | ON | ON | OFF | ON |
| 1320 | Finish optional cooling | OFF | OFF | OFF | OFF | ON |
| 1410 | Start optional transfer | OFF | OFF | ON | OFF | OFF |
| | removal | | | | | |
| 1420 | Pressurize 2^{nd} sub- | OFF | OFF | ON | ON | OFF |
| | chamber | | | | | |
| 1430 | Finish transfer removal | OFF | OFF | OFF | OFF | OFF |

One skilled in the art will recognize that the steps 1410 to 1420 can be executed in a controlled manner to apply a quick, substantial force to the decorating film, by simultaneously applying vacuum to the first sub-chamber and applying compressed air to the second sub-chamber. The effect of this technique would be like ripping off a band-aid quickly. Alternatively, the two steps can be executed in a smooth, continuous change by first applying compressed air to the second sub-chamber to gently lift the decorating film from the substrate, followed by slowly applying vacuum to the first sub-chamber to continue the process of removing the decorating film from the substrate.

In operation, a method of applying a decorating film to a substrate for transferring an graphic contained thereon comprises initial set-up steps. A substrate is placed or mounted onto a substrate support and a decorating film is secured to a chamber platen. The chamber cover is secured to the chamber platen, thereby forming a chamber and fixing the decorating film between the chamber cover and the chamber platen. The decorating film, secured between the chamber cover and chamber platen, thereby forms two sub-chambers within the chamber. The first sub-chamber substantially comprises an area enclosed by the chamber cover and the decorating film. The chamber cover comprises heating elements of two types, a controllable vacuum source, a controllable compressed air source, a combination pressure and vacuum sensor, and a temperature sensor. Each of the two heating element types is interfaced to a control system and is independently controllable. Each of the controllable vacuum and compressed air sources is interfaced to the control system and is independently controllable. The temperature sensor is also interfaced to the control system. The second sub-chamber substantially comprises an area enclosed by the chamber platen and the decorating film. The second sub-chamber contains the substrate mount and the substrate. The chamber platen comprises a combination pressure and vacuum sensor, a controllable vacuum source and a controllable compressed air source, each interfaced to the control system. The control system is programmed to carry out the method steps described above, and as claimed below.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications are able to be made in the embodiments chosen for illustration without departing from the spirit and scope of the invention as defined by the claims.

We claim:

1. A method of applying a decorating film to a substrate in a chamber containing the substrate and the decorating film, the decorating film defining a first sub-chamber and a second-sub-chamber within the chamber each coupled to a vacuum source, the chamber comprising a heating source, the method comprising the steps:
a. heating the chamber to a first temperature;
b. applying a vacuum to both the first and second sub-chambers;
c. stopping the vacuum to the first sub-chamber; and
d. applying a compressed air source to the first sub-chamber.

2. The method of claim 1, wherein heating the chamber comprises applying at least one of a plurality of heat sources to the chamber.

3. The method of claim 2, wherein one of the plurality of heat sources comprises an infra-red heat source.

4. The method of claim 1, further comprising heating the chamber at a second temperature after stopping the vacuum to the first sub-chamber.

5. The method of claim 4, further comprising cooling the chamber.

6. The method of claim 4, further comprising maintaining the heating of the chamber at the second temperature for a pre-determined period of time.

7. The method of claim 6, further comprising:
a. stopping the application of compressed air to the first sub-chamber; and
b. applying a vacuum to the first sub-chamber.

8. The method of claim 7, further comprising applying compressed air to the second sub-chamber.

9. A system for applying a decorating film to a substrate comprising:
a. a chamber configured to receive a substrate and a decorating film, the decorating film defining a first sub-chamber and a second sub-chamber within the chamber;
b. a vacuum source coupled to each of the first and the second sub-chamber;
c. a compressed air source coupled to at least the first sub-chamber; and
d. a heating source coupled to the chamber.

10. The system of claim 9, wherein the heating source comprises a plurality of heating element types.

11. The system of claim 10, wherein at least one of the plurality of heating element types comprises an infra-red heating element.

12. The system of claim 10, further comprising a control system configured to:
a. control heating of the chamber;
b. control application of the vacuum source to each of the first and the second sub-chambers; and
c. control application of compressed air to at least the first sub-chamber.

13. The system of claim 12, wherein the control system is further configured to:
a. heat the chamber at a first temperature;
b. apply vacuum to each of the first sub-chamber and the second sub-chamber; then
c. stop the vacuum to the first sub-chamber and apply compressed air to the first sub-chamber; and
d. heat the chamber to a second temperature.

14. The system of claim 13, wherein the control system is further configured to maintain the heating of the chamber at the second temperature for a pre-determined period of time.

15. The system of claim 13, further wherein the control system is further configured to apply a vacuum to the first sub-chamber.

16. The system of claim 15, further comprising a compressed air source coupled to the second sub-chamber, wherein the control system is further configured to apply the compressed air to the second sub-chamber.

17. The system of claim 13, wherein the control system is further configured to cool the chamber.

18. The system of claim 17, further comprising a compressed air source coupled to the second sub-chamber, wherein cooling the chamber comprises the application of compressed air and vacuum to at least one of the first sub-chamber and the second sub-chamber, thereby flowing cooling air within the at least one of the first sub-chamber and the second sub-chamber.

19. A non-transitory computer readable medium comprising processor executable instructions that, when executed, implement the method steps, practiced upon a chamber comprising a heating source and a compressed air source:
a. heating the chamber containing a substrate and a decorating film, wherein the decorating film defines a first sub-chamber and a second sub-chamber within the chamber, each sub-chamber is coupled to a vacuum source;
b. applying a vacuum to both the first and the second sub-chambers;
c. stopping the vacuum to the first sub-chamber; and
d. applying compressed air to the first sub-chamber.
